(19) United States
(12) Patent Application Publication
(10) Pub. No.: US 2025/0312861 A1
(43) Pub. Date: Oct. 9, 2025

(54) WELDING CONDITION DETERMINING SYSTEM, LEARNING SYSTEM, WELDING SYSTEM, AND WELDING TARGET MANUFACTURING METHOD

(71) Applicant: Mitsubishi Electric Corporation, Chiyoda-ku, Tokyo (JP)

(72) Inventors: Masaaki SAKAKIBARA, Chiyoda-ku, Tokyo (JP); Yoshihiro HOSOKAWA, Chiyoda-ku, Tokyo (JP)

(73) Assignee: Mitsubishi Electric Corporation, Chiyoda-ku, Tokyo (JP)

(21) Appl. No.: 18/863,400

(22) PCT Filed: May 2, 2023
(86) PCT No.: PCT/JP2023/017209

§ 371 Date: Nov. 6, 2024

(30) Foreign Application Priority Data
May 11, 2022 (JP) 2022-078041

(51) Int. Cl. B23K 9/095

(52) U.S. Cl. CPC B23K 9/095

(57) ABSTRACT

A welding condition determining system includes a welding condition setter, welding result estimator, and welding condition determiner. The welding condition setter receives data indicating a non-adjustable welding condition or a fixed welding condition for welding of welding targets, and a required welding result, and sets a provisional adjustable welding condition as a flexible welding condition. The welding result estimator estimates a welding result, based on the non-adjustable welding condition and provisional adjustable welding condition, using a welding result estimation model designed to output data indicating an estimated welding result from an output layer in response to input of data indicating the non-adjustable welding condition and provisional adjustable welding condition into an input layer. The welding condition determiner finalizes, based on the welding result estimated by the welding result estimator and the required welding result, a welding condition containing an adjustable welding condition.

Buchanan

### TECHNICAL FIELD

The present disclosure relates to a welding condition determining system, a learning system, a welding condition determining method, and a program.

### BACKGROUND ART

If metal targets are welded under welding conditions, such as current value and welding speed, inappropriate for the material or thickness of the targets, the targets after welding have distortion or warpage. Required is to set appropriate welding conditions.

To set appropriate welding conditions, Patent Literature 1 discloses a welding control device that retrieves, from a condition database, welding conditions associated with data indicating the shape of a base material in each of set regions. When a welding robot performs welding in accordance with the retrieved welding conditions, the welding control device calculates a quality score indicating the quality of the welding, and updates the welding conditions stored in the condition database so as to increase the quality score in each of the set regions.

### CITATION LIST

### Patent Literature

Patent Literature 1: Unexamined Japanese Patent Application Publication No. 2021-178331

### SUMMARY OF INVENTION

### Technical Problem

The welding control device disclosed in Patent Literature 1 needs a condition database that stores welding conditions prepared in advance. The condition database must be updated by a user after an actual welding process under conditions not stored in the prepared database. The user thus finds it difficult to determine welding conditions.

An objective of the present disclosure, which has been accomplished in view of the above situations, is to provide a welding condition determining system, a learning system, a welding condition determining method, and a program that facilitate setting of welding conditions.

### Solution to Problem

In order to achieve the above objective, a welding condition determining system according to the present disclosure includes: a welding condition setter to receive data indicating a non-adjustable welding condition and a required welding result, the non-adjustable welding condition being a fixed welding condition for welding of welding targets, and set a provisional adjustable welding condition as a flexible welding condition;

a welding result estimator to estimate a welding result, based on the non-adjustable welding condition and the provisional adjustable welding condition, using a welding result estimation model designed to output data indicating an estimated welding result from an output layer in response to input of data indicating the non-adjustable welding condition and the provisional adjustable welding condition into an input layer; and a welding condition determiner to finalize, based on the welding result estimated by the welding result estimator and the required welding result, a welding condition containing an adjustable welding condition.

### Advantageous Effects of Invention

The welding condition determining system according to the present disclosure estimates a welding result on the basis of the non-adjustable welding condition and the provisional adjustable welding condition and finalizes a welding condition on the basis of the estimated welding result, and can thus facilitate setting of welding conditions.

### BRIEF DESCRIPTION OF DRAWINGS

FIG. 1 is an external view of a welding condition determining system and a welding apparatus according to an embodiment of the present disclosure;

FIG. 2 is a block diagram illustrating the welding condition determining system according to the embodiment of the present disclosure;

FIG. 3 illustrates the welding condition determining system according to the embodiment of the present disclosure;

FIG. 4 illustrates an adjustable welding condition DB according to the embodiment of the present disclosure;

FIG. 5 is a flowchart illustrating a welding condition determining process according to the embodiment of the present disclosure;

FIG. 6 illustrates a learning system according to the embodiment of the present disclosure;

FIG. 7 illustrates a learning device according to the embodiment of the present disclosure;

FIG. 8 illustrates a welding simulation condition DB according to the embodiment of the present disclosure;

FIG. 9 illustrates a welding simulation result DB according to the embodiment of the present disclosure;

FIG. 10 is a flowchart illustrating a learning process according to the embodiment of the present disclosure;

FIG. 11 is a flowchart illustrating a modification of the welding condition determining process;

FIG. 12 is a flowchart illustrating another modification of the welding condition determining process;

FIG. 13 is a flowchart illustrating another modification of the welding condition determining process;

FIG. 14 is a flowchart illustrating another modification of the welding condition determining process;

FIG. 15 is a flowchart illustrating another modification of the welding condition determining process; and

FIG. 16 illustrates a modification of the learning system.

### DESCRIPTION OF EMBODIMENTS

A welding condition determining system, a learning system, a welding condition determining method, and a program according to an embodiment of the present disclosure are described below with reference to the accompanying drawings.

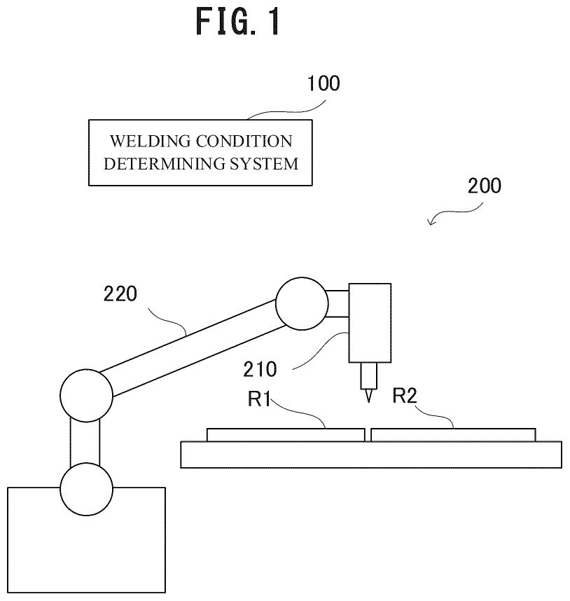

A welding condition determining system 100 according to the embodiment determines welding conditions that achieve a welding result required for a product, when a welding apparatus 200 performs welding of a first welding target R1 and a second welding target R2, as illustrated in FIG. 1. The welding apparatus 200 includes a welding head 210 including a welding torch, and a welding robot 220 including an arm that shifts the welding head 210 along positions to be welded. Examples of the welding conditions include a welding current value indicating a value of current applied in arc discharge, and a welding speed indicating a speed of shifting the welding head 210.

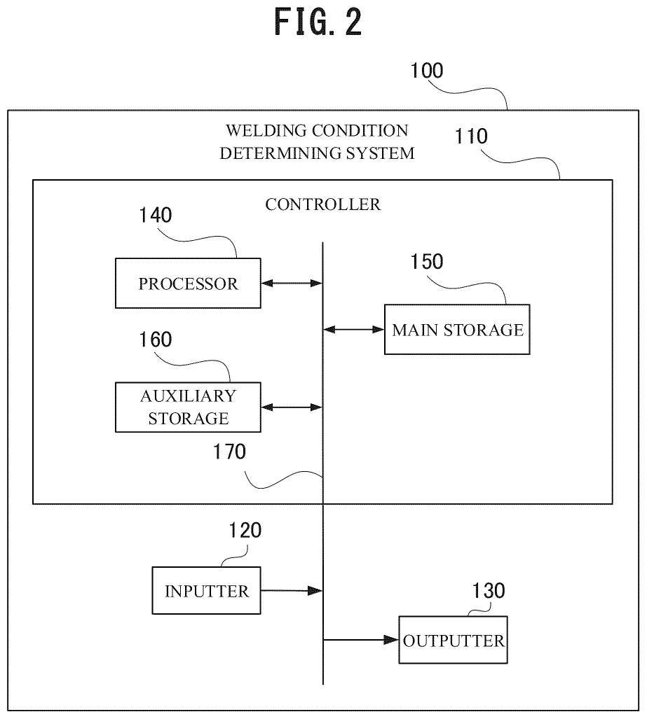

As illustrated in FIG. 2, the welding condition determining system 100 includes a controller 110 that executes a process of determining welding conditions, an inputter 120 that inputs data, and an outputter 130 that outputs data.

The controller 110 includes a processor 140 that executes programs, a main storage 150 that serves as a work area of the processor 140, and an auxiliary storage 160 that stores various types of data and programs to be used in the processes of the processor 140. The main storage 150 and the auxiliary storage 160 are each connected to the processor 140 via buses 170.

The processor 140 includes a micro processing unit (MPU). The processor 140 executes a program stored in the auxiliary storage 160 and thereby performs various functions of the welding condition determining system 100.

The main storage 150 includes a random access memory (RAM). The main storage 150 receives the program loaded from the auxiliary storage 160. The main storage 150 serves as a work area of the processor 140.

The auxiliary storage 160 includes a non-volatile memory, such as electrically erasable programmable read-only memory (EEPROM). The auxiliary storage 160 stores the program and various types of data to be used in the processes of the processor 140. The auxiliary storage 160 provides the processor 140 with data to be used by the processor 140 and stores data fed from the processor 140, under the instructions from the processor 140.

Examples of the inputter 120 include an input device, such as mouse, touch panel, or keyboard, through which a user inputs data, a serial port, a universal serial bus (USB) port, and a local area network (LAN) port. The inputter 120 provides the input data to the processor 140.

Examples of the outputter 130 include an output device, such as display or printer, an output device capable of outputting data to another computer system or control device, and a combination thereof. The outputter 130 may output data to the welding apparatus 200.

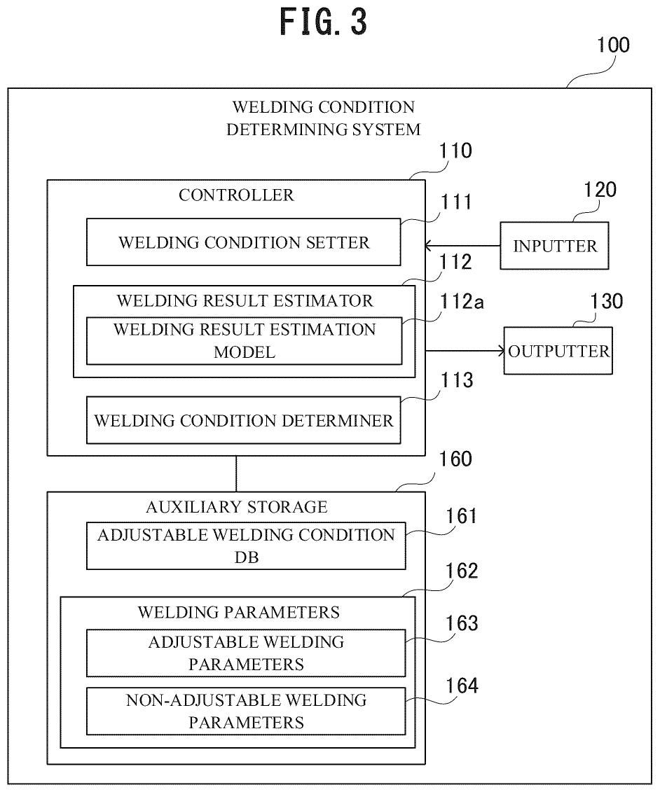

As illustrated in FIG. 3, the controller 110, when executing the program stored in the auxiliary storage 160, functions as a welding condition setter 111 that sets a provisional adjustable welding condition, a welding result estimator 112 that estimates a welding result on the basis of the provisional adjustable welding condition set by the welding condition setter 111, and a welding condition determiner 113 that finalizes welding conditions on the basis of the welding result estimated by the welding result estimator 112.

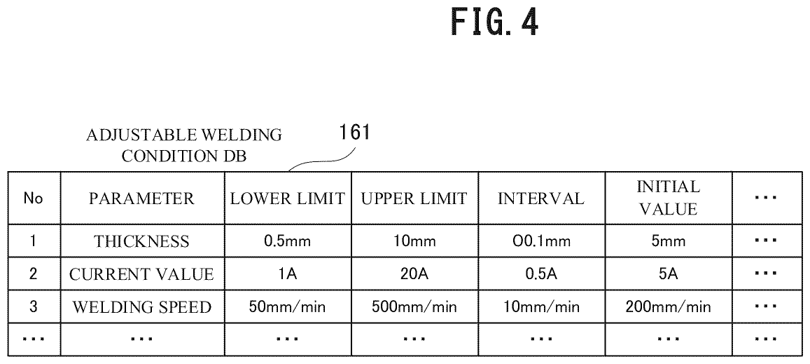

The welding condition setter 111 receives data indicating a non-adjustable welding condition, which is a fixed welding condition for welding of welding targets, and a required welding result, and sets a provisional adjustable welding condition as a flexible welding condition. In detail, the welding condition setter 111 receives data indicating a non-adjustable welding condition and data indicating a required welding result input through the inputter 120, and causes the data to be stored into the main storage 150. The non-adjustable welding condition indicates values of parameters contained in non-adjustable welding parameters 164. Examples of the non-adjustable welding condition include thicknesses of the first and second welding targets R1 and R2, materials of the first and second welding targets R1 and R2, and an environmental temperature. The required welding result indicates values of parameters. Examples of the required welding result include “amount of distortion”, “displacement at a certain position”, “flatness”, “color”, “welding strength”, “shape of welding beads”, “amount of shrinkage”, and combinations thereof. The required welding result may indicate ranges of values of parameters associated with the welding result. In general, the parameter “amount of distortion” or “flatness” at a specific site is often important in welding, due to requirements in design. The required welding result contains an amount of distortion or flatness equal to or smaller than a reference value, for example. The required welding result indicates one or more parameters, although a smaller number of parameters can achieve a better estimation conclusion. The welding condition setter 111 sets a provisional adjustable welding condition, which is selected from among the adjustable welding conditions stored in an adjustable welding condition database (DB) 161 of the auxiliary storage 160, and causes the set provisional adjustable welding condition to be stored into the main storage 150. The exemplary adjustable welding condition DB 161 illustrated in FIG. 4 stores adjustable welding conditions, including thicknesses from 0.5 to 10 mm with an interval of 0.1 mm starting from an initial thickness of 5 mm, current values from 1 to 20 A with an interval of 0.5 A starting from an initial current value of 5A, and welding speeds from 50 to 500 mm/min with an interval of 10 mm/min starting from an initial welding speed of 200 mm/min. The initial values are each a value initially applied as a provisional adjustable welding condition. The adjustable welding condition DB 161, if containing many adjustable welding conditions, is more likely to contribute to acquisition of welding conditions that provide the required welding result, but needs a longer time for calculation.

The welding result estimator 112 estimates a welding result on the basis of the non-adjustable welding condition and the provisional adjustable welding condition. In detail, the welding result estimator 112 inputs the non-adjustable welding condition and the provisional adjustable welding condition into a welding result estimation model 112a, and thus estimates a welding result. The welding result estimation model 112a is designed to output data indicating a welding result, in response to input of data containing a non-adjustable welding condition and a provisional adjustable welding condition. The welding result estimation model 112a may be a mathematical model that outputs data indicating a welding result, in response to input of data indicating a non-adjustable welding condition and a provisional adjustable welding condition. The welding result estimation model 112a preferably includes at least one convolutional layer and at least one pooling layer. The welding result estimation model 112a is established through learning by means of multidimensional function fitting, decision tree, support vector machine, or neural network, using a database that stores supervision data containing at least one adjustable welding parameter and at least one or more required welding results or parameters from which required welding results are calculatable, although this process is described below. The welding result estimation model 112a includes an input layer and an output layer, and preferably includes at least one convolutional layer and at least one pooling layer between the input layer and the output layer. For example, when the welding result estimation model 112a receives, at the input layer, data indicating a non-adjustable welding condition containing materials and thicknesses of the first and second welding targets R1 and R2 and data indicating a provisional adjustable welding condition containing a current value and a welding speed, the welding result estimation model 112a outputs data indicating a parameter “amount of distortion”, “displacement at a certain position”, “flatness”, “color”, “welding strength”, “shape of welding beads” or “amount of shrinkage” from the output layer.

The welding condition determiner 113 finalizes welding conditions containing an adjustable welding condition, on the basis of the welding result estimated by the welding result estimator 112 and a required welding result. In detail, the welding condition determiner 113 determines whether the welding result estimated by the welding result estimator 112 complies with the required welding result. When determining that the estimated welding result complies with the required welding result, the welding condition determiner 113 finalizes the adjustable welding condition, and outputs data indicating welding conditions containing the finalized adjustable welding condition from the outputter 130.

The auxiliary storage 160 stores the adjustable welding condition DB 161 and welding parameters 162. The welding parameters 162 contain adjustable welding parameters 163 and the non-adjustable welding parameters 164. The adjustable welding parameters 163 are flexible welding parameters, and contain a welding current value and a welding speed. The non-adjustable welding parameters 164 are fixed welding conditions for welding, and contain thicknesses of the first and second welding targets R1 and R2, materials of the first and second welding targets R1 and R2, or an environmental temperature. A certain parameter may be classified into the adjustable welding parameters 163 or the non-adjustable welding parameters 164, depending on whether the classification is performed during or after the design phase. That is, the thicknesses of the first and second welding targets R1 and R2 and the materials of the first and second welding targets R1 and R2 may be classified into the adjustable welding parameters 163 during the design phase. The welding parameters 162 may contain a welding current, welding speed, heat input efficiency, groove shape, and heat capacity, and preferably contain a welding current and welding speed among these parameters. The number of adjustable welding parameters 163 is one or more, and the number of non-adjustable welding parameters 164 is zero or more. The adjustable welding conditions indicate values of parameters contained in the individual adjustable welding parameters 163. The non-adjustable welding conditions indicate values of parameters contained in the non-adjustable welding parameters 164.

The welding condition determining system 100 having the above-described configuration executes a welding condition determining process, which is described below.

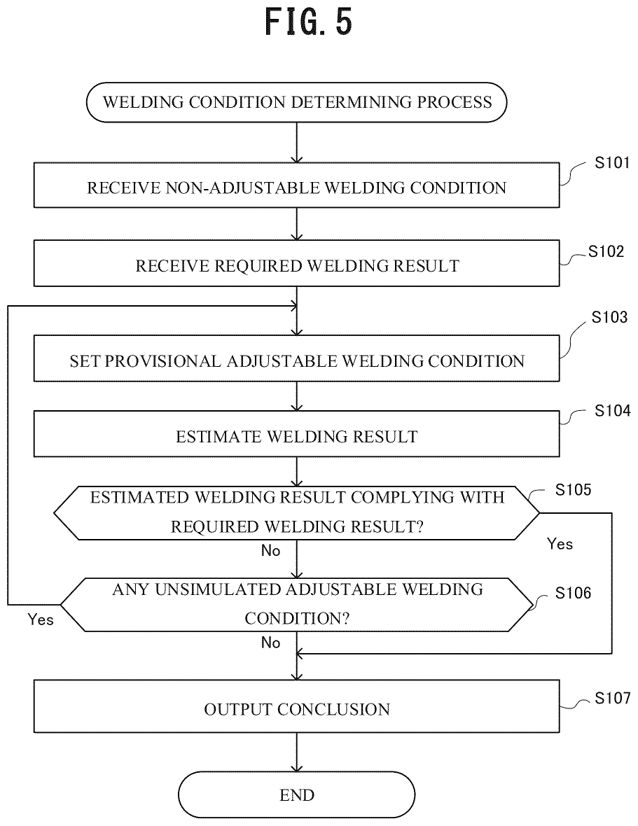

In response to an instruction for initiating a process provided from the user, the welding condition determining system 100 initiates the welding condition determining process illustrated in FIG. 5. The following describes the welding condition determining process executed by the welding condition determining system 100 with reference to the flowchart, focusing on an example for acquiring welding conditions for welding of the first and second welding targets R1 and R2 and providing a welding result “amount of distortion” equal to or smaller than a reference value. In this example, the first and second welding targets R1 and R2 are made of stainless used steel (SUS) and have a thickness of 5 mm.

At the start of the welding condition determining process, the welding condition setter 111 receives data indicating a non-adjustable welding condition input through the inputter 120 (Step S101), and causes the data to be stored into the main storage 150. The non-adjustable welding condition is a fixed welding condition for welding of welding targets, and contains thicknesses of the first and second welding targets R1 and R2, materials of the first and second welding targets R1 and R2, or an environmental temperature. In this example for welding of the first and second welding targets R1 and R2 made of SUS and having a thickness of 5 mm, the user manipulates the inputter 120 and thus inputs, as the non-adjustable welding condition, data indicating a material of SUS and data indicating a thickness of 5 mm.

The welding condition setter 111 then receives data indicating a required welding result input through the inputter 120 (Step S102), and causes the data to be stored into the main storage 150. The welding result indicates parameters, examples of which include “amount of distortion”, “displacement at a certain position”, “flatness”, “color”, “welding strength”, “shape of welding beads”, “amount of shrinkage”, and combinations thereof. The required welding result may indicate ranges of values of parameters. In this example, the user manipulates the inputter 120, and thus selects the parameter “amount of distortion” as a welding result, and inputs data indicating a required welding result indicating that the parameter “amount of distortion” is equal to or smaller than a reference value.

The welding condition setter 111 then sets a provisional adjustable welding condition, which is selected from among the adjustable welding conditions stored in the adjustable welding condition DB 161 (Step S103), and causes data indicating the set provisional adjustable welding condition to be stored into the main storage 150. In this example, the set provisional adjustable welding condition contains an initial current value of 5 A and an initial welding speed of 200 mm/min.

The welding result estimator 112 inputs the non-adjustable welding condition received in Step S101 and the provisional adjustable welding condition set in Step S103 into the welding result estimation model 112a, and thus estimates a welding result (Step S104). The welding result estimator 112 causes data indicating the estimated welding result to be stored into the main storage 150. The welding result estimation model 112a is designed to output, in response to input of welding parameters indicated by a non-adjustable welding condition and a provisional adjustable welding condition into the input layer, data indicating a welding result from the output layer.

The welding condition determiner 113 then determines whether the welding result estimated in Step S104 complies with the required welding result (Step S105). In this example, the welding condition determiner 113 determines whether the estimated welding result indicating a parameter “amount of distortion” complies with the required welding result. When determining that the estimated welding result complies with the required welding result (Step S105; Yes), the welding condition determiner 113 finalizes welding conditions containing the adjustable welding condition, and outputs data indicating the finalized welding conditions (Step S107). The welding condition determining process is then terminated.

In contrast, when determining that the estimated welding result fails to comply with the required welding result (Step S105; No), the welding condition determiner 113 determines whether any adjustable welding condition remains unsimulated, among the adjustable welding conditions stored in the adjustable welding condition DB 161 (Step S106). When the welding condition determiner 113 determines that any adjustable welding condition remains unsimulated (Step S106; Yes), the process returns to Step S103, and repeats Steps S103 to S106 with respect to a provisional adjustable welding condition that has not been set. In this example, the process repeats Steps S103 to S106 while varying either a current value or a welding speed contained in the provisional adjustable welding condition, until acquiring a welding result indicating a parameter “amount of distortion” equal to or smaller than the reference value. When the welding condition determiner 113 acquires a welding result indicating a parameter “amount of distortion” equal to or smaller than the reference value by varying either a current value or a welding speed contained in the provisional adjustable welding condition, the welding condition determiner 113 outputs welding conditions containing the adjustable welding condition that provides the welding result indicating a parameter “amount of distortion” equal to or smaller than the reference value (Step S107). In contrast, when determining that no adjustable welding condition remains unsimulated (Step S106; No), the welding condition determiner 113 outputs a conclusion that no adjustable welding condition is acquired that provides the required welding result (Step S107). The welding condition determining process is then terminated.

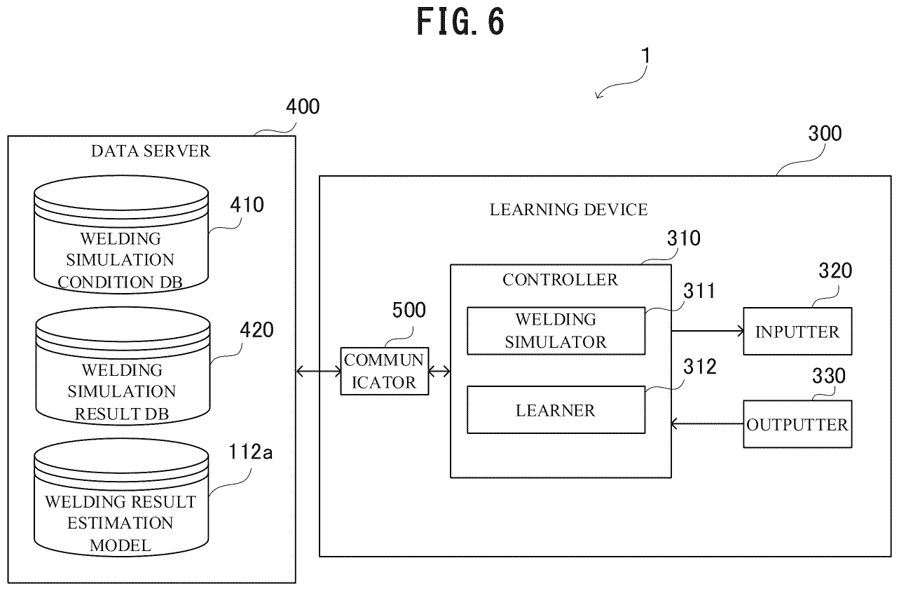

The following describes a leaning system 1 for establishing the welding result estimation model 112a. As illustrated in FIG. 6, the learning system 1 includes a learning device 300 that executes learning, and a data server 400 that stores data used in the learning. The learning device 300 includes a controller 310 that executes a learning process, an inputter 320 that receives input data, an outputter 330 that outputs data, and a communicator 500 that communicates with the data server 400.

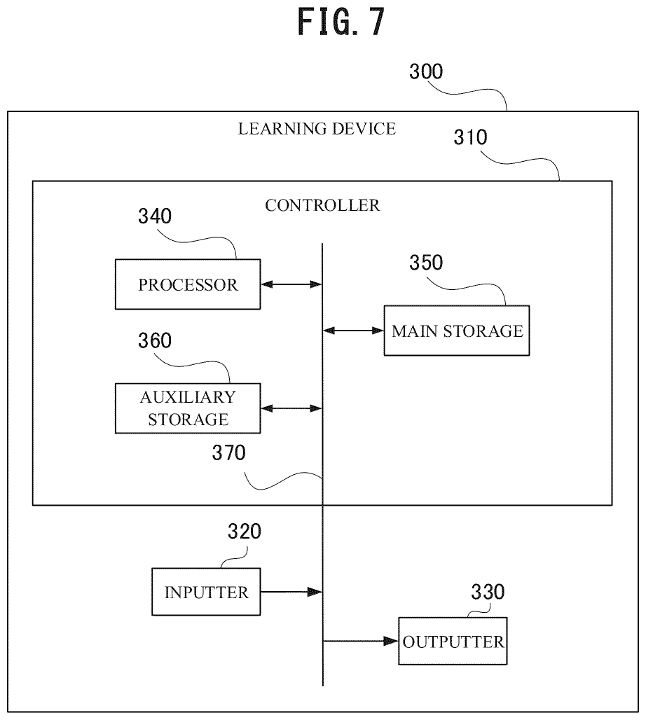

As illustrated in FIG. 7, the controller 310 includes a processor 340 that executes a learning process, a main storage 350 that serves as a work area of the processor 340, and an auxiliary storage 360 that stores various types of data and programs to be used in the processes of the processor 340. The main storage 350 and the auxiliary storage 360 are each connected to the processor 340 via buses 370.

The inputter 320, the outputter 330, the processor 340, the main storage 350, and the auxiliary storage 360 respectively have the same configurations as the above-described configurations of the inputter 120, the outputter 130, the processor 140, the main storage 150, and the auxiliary storage 160 of the welding condition determining system 100.

The controller 310, when executing the program stored in the auxiliary storage 360, functions as a welding simulator 311 that executes a welding simulation, and a learner 312 that executes learning for establishing the welding result estimation model 112a, as illustrated in FIG. 6.

The welding simulator 311 obtains a set of welding conditions for execution of a single simulation from a welding simulation condition DB 410, and executes a numerical simulation for acquiring a welding result in accordance with the obtained set of welding conditions. The welding simulator 311 thus acquires a welding result for each set of welding conditions. The welding conditions need to contain one or more parameters among the adjustable welding parameters to be used in the welding condition determining system 100. The welding results need to contain at least one or more required welding results to be used in the welding condition determining system 100 or parameters from which the welding results are calculatable. The welding simulator 311 may acquire a welding result through not only numerical simulations executed by a computer but also actual experiments. The welding simulator 311 outputs results of the executed welding simulations to the welding simulation result DB 420.

The learner 312 executes learning for establishing the welding result estimation model 112a, on the basis of the supervision data stored in the welding simulation result DB 420. The welding result estimation model 112a includes an input layer and an output layer, and preferably includes at least one convolutional layer and at least one pooling layer between the input layer and the output layer. In order to establish a welding result estimation model 112a, designed to output supervision data indicating a welding result stored in the welding simulation result DB 420 from the output layer of the welding result estimation model 112a in response to input of data indicating a set of welding conditions stored in the welding simulation result DB 420 into the input layer, the learner 312 optimizes the functions contained in the welding result estimation model 112a and thus establishes the welding result estimation model 112a. The welding result estimation model 112a can acquire a welding result from welding conditions, with a smaller amount of calculation than a welding simulation executed by the welding simulator 311.

The communicator 500 executes wired or wireless communication with the data server 400. The communicator 500 receives signals from the data server 400, and outputs data indicated by the received signals to the processor 340. The communicator 500 also transmits, to the data server 400, signals indicating data output from the processor 340.

The data server 400 includes the welding simulation condition DB 410 that stores welding conditions for welding simulations, and the welding simulation result DB 420 that stores results of the welding simulations.

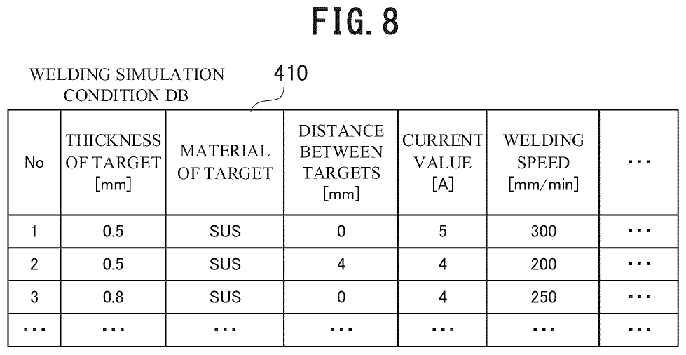

As illustrated in FIG. 8, the welding simulation condition DB 410 stores data indicating welding conditions for welding simulations. The welding simulation condition DB 410 stores one or more parameters among the adjustable welding parameters. In the above-described example in which the adjustable welding parameters contain a current value and a welding speed, the welding conditions for welding simulations contain the current value and the welding speed. The welding conditions do not necessarily contain a non-adjustable welding parameter, and may contain any or none of the non-adjustable welding parameters. The welding simulation condition DB 410 may be prepared by preliminarily definition of all the conditions, designation of a range and granularity of each parameter, or a combination thereof. For example, the stored parameters contain thicknesses from 0.5 to 10 mm with an interval of 0.1 mm, current values from 1 to 20 A with an interval of 0.5 A, and welding speeds from 100 to 500 mm/min with an interval of 10 mm/min. The welding simulation condition DB 410, which virtually contains parameters in terms of relationship between databases, is also deemed to contain the parameters.

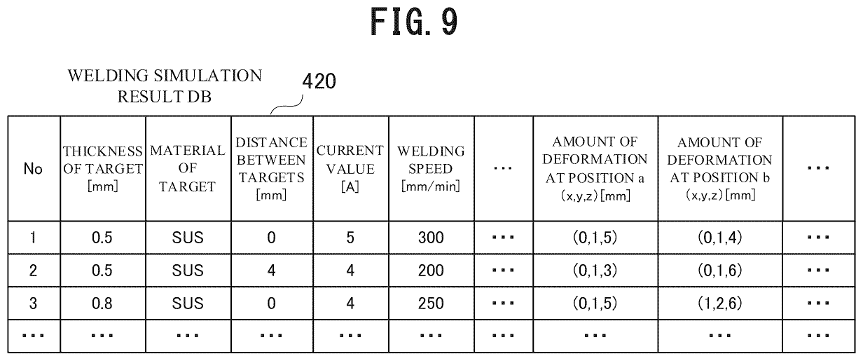

As illustrated in FIG. 9, the welding simulation result DB 420 is a list of multiple welding conditions and results of welding simulations associated with the respective welding conditions. The welding simulation result DB 420 contains one or more parameters and an adjustable welding parameter identical to the parameters in the welding simulation condition DB 410. For example, the welding simulation result DB 420 contains current values and welding speeds. The welding simulation result DB 420 contains at least one or more parameters associated with welding results and data indicating the welding results. The parameters associated with welding results contain at least one or more required welding results or parameters from which the required welding results are calculatable, which are to be used in the above-described welding condition determining process. In an exemplary case where the welding result estimation model 112a outputs a welding result indicating a parameter “amount of distortion”, the welding simulation result DB 420 contains data indicating parameters “amount of distortion” or data from which the parameters “amount of distortion” are calculatable, in order to establish the welding result estimation model 112a capable of outputting a parameter “amount of distortion”. Some of the welding parameters 162 illustrated in FIG. 3 that are not contained in the parameters in the welding simulation result DB 420 may be deleted in the above-described welding condition determining process.

The learning device 300 having the above-described configuration executes a learning process, which is described below.

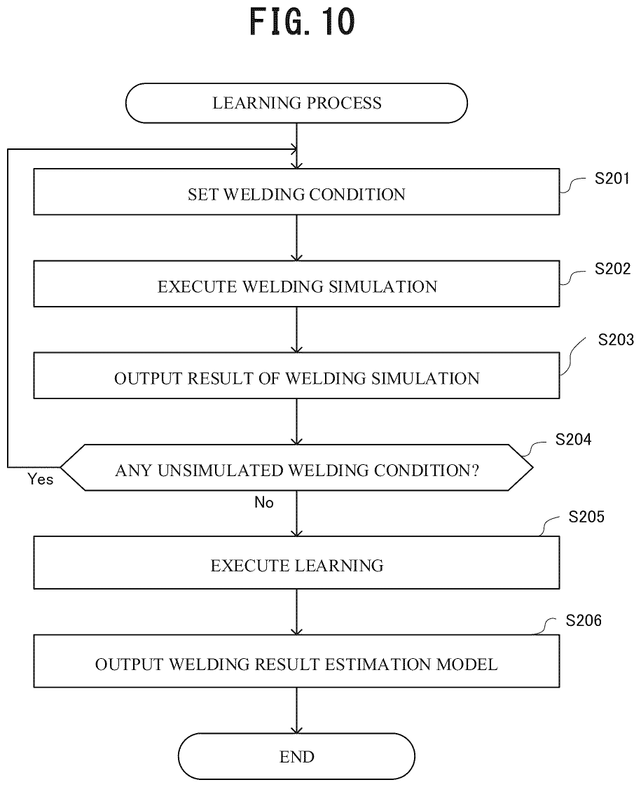

In response to an instruction for initiating a process provided from the user, the learning device 300 initiates the learning process illustrated in FIG. 10. The following describes the learning process executed by the learning device 300 with reference to the flowchart.

At the start of the learning process, the welding simulator 311 obtains data indicating a set of welding conditions for execution of a single simulation from the welding simulation condition DB 410, and sets the set of welding conditions (Step S201). The input welding conditions contain one or more parameters among the adjustable welding parameters. In the example illustrated in FIG. 8, the input welding conditions contain a current value and a welding speed as the adjustable welding parameters.

The welding simulator 311 then executes a welding simulation (Step S202). The welding simulation is a numerical simulation for acquiring a welding result in response to input of welding conditions, by means of a finite element method, for example. The welding result contains at least one or more required welding results or parameters from which required welding results are calculatable. In an exemplary case where a parameter “amount of distortion” is designated as the required welding result, the welding simulation result DB 420 contains data indicating a parameter “amount of distortion” or data from which a parameter “amount of distortion” is calculatable. In the example illustrated in FIG. 9, the amount of deformation at a position a and the amount of deformation at a position b correspond to data from which a parameter “amount of distortion” is calculatable.

The welding simulator 311 then outputs results of the executed welding simulations to the welding simulation result DB 420 (Step S203).

The welding simulator 311 then determines whether any set of welding conditions remains unsimulated among the welding conditions stored in the welding simulation condition DB 410 (Step S204). When determining that any set of welding conditions remains unsimulated (Step S204; Yes), the process returns to Step S201, and repeats Steps S201 to S204 with respect to a set of welding conditions that has not been set. This process allows the welding simulation result DB 420 to store results of the welding simulations.

In contrast, when it is determined that no welding condition remains unsimulated (Step S204; No), the learner 312 executes learning for establishing the welding result estimation model 112a illustrated in FIG. 3, on the basis of the supervision data stored in the welding simulation result DB 420 (Step S205). The welding result estimation model 112a includes an input layer and an output layer, and preferably includes at least one convolutional layer and at least one pooling layer between the input layer and the output layer. In order to establish a welding result estimation model 112a, designed to output supervision data indicating a welding result stored in the welding simulation result DB 420 from the output layer of the welding result estimation model 112a in response to input of data indicating a set of welding conditions stored in the welding simulation result DB 420 into the input layer, the learner 312 optimizes the functions contained in the welding result estimation model 112a and thus establishes the welding result estimation model 112a. Exemplary algorithms for establishing the welding result estimation model 112a include multidimensional function fitting, decision tree, support vector machine, and neural network. The welding result estimation model 112a in any case outputs a welding result in response to input of a set of welding conditions, with a smaller amount of calculation than a welding simulation.

As is known, over-training impairs the estimation accuracy in any algorithm, and thus is preferably avoided regardless of the applied leaning model. The over-training can be avoided by normalization of data to be learned or reduction in the number of parameters in the model. In an exemplary case of multidimensional function fitting, the over-training can be avoided by limiting the number of dimensions of functions to be at most five. In another exemplary case of a neural network model, the over-training can be effectively avoided by limiting the number of intermediate layers to be at most ten. The over-training can also be effectively avoided by causing a certain layer of a learning model to output a value of 0 at random in the leaning phase in the case of the neural network model. The over-training can also be effectively avoided by a combination of these procedures.

The learner 312 then outputs the established welding result estimation model 112a to the data server 400 (Step S206). The welding result estimation model 112a is thus stored into the data server 400. The learning process is then terminated.

The welding condition determining system 100 having the above-described configuration estimates a welding result on the basis of a non-adjustable welding condition and a provisional adjustable welding condition, using the welding result estimation model 112a established by the learning device 300, and can thus readily finalize welding conditions. This welding condition determining system 100 can rapidly output welding conditions that provide a required welding result, even with respect to unknown welding conditions, while maintaining the higher estimation accuracy. The welding condition determining system 100 can thus achieve both of improvement of the estimation accuracy and reduction in the calculation amount. Specifically, the welding condition determining system 100 can readily calculate welding conditions that provide a parameter “amount of distortion” of welding targets after welding that is equal to or smaller than a required value. The welding condition determining system 100 can readily acquire, as well as a parameter “amount of distortion”, welding conditions that provide a required welding result indicating a preferable parameter, such as “displacement at a certain position”, “flatness”, “color”, “welding strength”, “shape of welding beads”, or “amount of shrinkage”, or other required welding results.

In contrast, determining welding conditions based on welding experiments is a troublesome task because welding experiments take an extremely long time. Determining welding conditions by a finite element method of computer simulation can achieve high estimation accuracy, but requires a large amount of calculation and a long calculation period. In contrast, determining welding conditions by a calculation method using a numerical model including low-dimensional functions can achieve a small amount of calculation, but suffers from low estimation accuracy if the state exceeds preconditions defined in accordance with reduction in the dimension. That is, methods of computer simulation cannot readily achieve both of high estimation accuracy and high calculation speed.

### Modifications

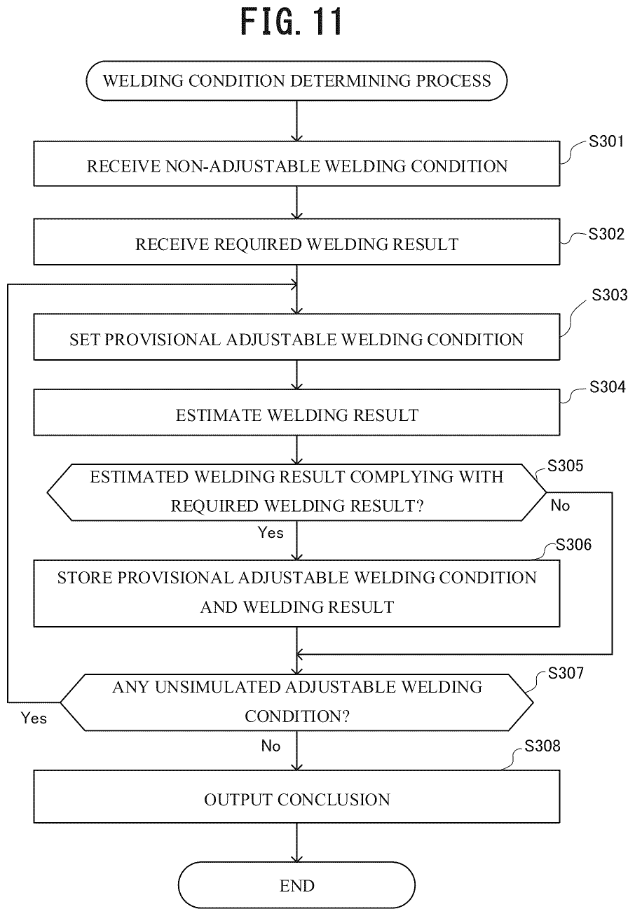

In the welding condition determining process executed by the welding condition determining system 100 in the above-described embodiment, when the welding condition determiner 113 determines that the estimated welding result complies with the required welding result in Step S105, the welding condition determiner 113 finalizes welding conditions and outputs the finalized welding conditions as a conclusion. The welding condition determining process may be modified like that illustrated in FIG. 11. Specifically, when the estimated welding result complies with the required welding result in Step S305, the welding condition determiner 113 may cause data indicating the provisional adjustable welding condition and the estimated welding result to be stored into the main storage 150, followed by repetition of Steps S303 to S307. Steps S301 to S304 are identical to Steps S101 to S104 of the above-described welding condition determining process. In Step S305, the welding condition determiner 113 determines whether the welding result estimated in Step S304 complies with the required welding result. When determining that the estimated welding result complies with the required welding result (Step S305; Yes), the welding condition determiner 113 causes the provisional adjustable welding condition and the estimated welding result to be stored into the main storage 150 (Step S306). In contrast, when the welding condition determiner 113 determines that the estimated welding result fails to comply with the required welding result (Step S305; No), the process goes to Step S307.

The welding condition determiner 113 then determines whether any adjustable welding condition remains unsimulated (Step S307). When the welding condition determiner 113 determines that any adjustable welding condition remains unsimulated (Step S307; Yes), the process returns to Step S303, and repeats Steps S303 to S307 with respect to a provisional adjustable welding condition that has not been set. In contrast, when determining that no adjustable welding condition remains unsimulated (Step S307; No), the welding condition determiner 113 reads the provisional adjustable welding conditions and the estimated welding results stored in the main storage 150, and outputs an adjustable welding condition that provides the most preferable welding result, adjustable welding conditions extracted under predetermined conditions, or all the adjustable welding conditions, among the read provisional adjustable welding conditions and estimated welding results (Step S308). When the welding condition determiner 113 fails to find any adjustable welding condition that provides the required welding result, the welding condition determiner 113 outputs a conclusion of acquisition of no adjustable welding condition that provides the required welding result. The welding condition determiner 113 then terminates the welding condition determining process. This welding condition determiner 113 can calculate an adjustable welding condition that provides a more preferable estimated welding result. Limiting the number of repetitions of Steps S303 to S307 and the calculation period in advance can avoid an increase in the calculation period. This configuration allows the system to rapidly output welding conditions that provide a required welding result, even with respect to an unknown welding condition, while maintaining the estimation accuracy higher than that in a conventional technique.

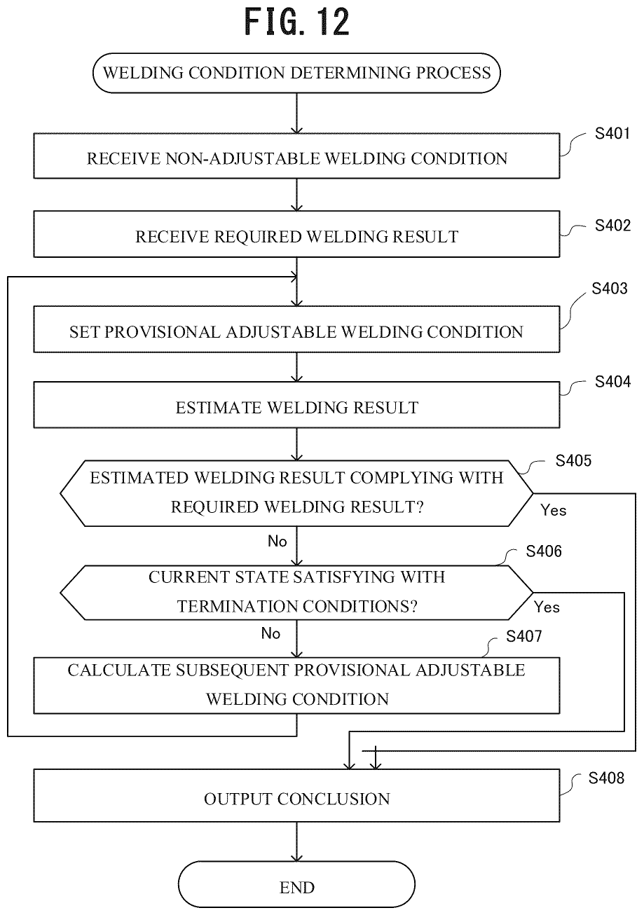

In the welding condition determining system 100 according to the above-described embodiment, when the estimated welding result is determined to fail to comply with the required welding result, the welding condition setter 111 sets a provisional adjustable welding condition that has not been set. Alternatively, the welding condition setter 111 may set a provisional adjustable welding condition calculated by a mathematical procedure for optimal exploration. Examples of the mathematical procedure for optimal exploration include Bayesian optimization and quantum optimization. The Bayesian optimization is preferred for the number of parameters equal to or smaller than ten. In this case, the welding condition determining process may be modified like that illustrated in FIG. 12. Specifically, in Step S407, the welding condition setter 111 calculates a subsequent provisional adjustable welding condition by a mathematical procedure for optimal exploration. The process then returns to Step S403, and repeats Steps S403 to S407 with respect to the calculated provisional adjustable welding condition. Steps S401 to S404 are identical to Steps S101 to S104 of the above-described welding condition determining process. The first execution of Step S403 involves setting a provisional adjustable welding condition by determination at random, empirical determination based on previous conditions, application of a constant value, or application of a value expected to be the best on the basis of a physical model for welding.

In detail, in Step S405, the welding condition determiner 113 determines whether the welding result estimated in Step S404 complies with the required welding result. When determining that the estimated welding result complies with the required welding result (Step S405; Yes), the welding condition determiner 113 outputs a conclusion (Step S408), and terminates the welding condition determining process. In contrast, when determining that the estimated welding result fails to comply with the required welding result (Step S405; No), the welding condition determiner 113 determines whether the current state satisfies termination conditions (Step S406). The determination of whether the current state satisfies the termination conditions depends on how many times Steps S403 to S407 have been repeated, or whether a certain period has elapsed since the time of the initial execution of Step S403. When the current state is determined to fail to satisfy the termination conditions (Step S406; No), the welding condition setter 111 sets a subsequent provisional adjustable welding condition calculated by a mathematical procedure for optimal exploration, as described above (Step S407). The process then returns to Step S403, and repeats Steps S403 to S407. In contrast, when determining that the current state satisfies the termination conditions (Step S406; Yes), the welding condition determiner 113 outputs a conclusion (Step S408), and terminates the welding condition determining process. This process can achieve finalization of welding conditions in a short period.

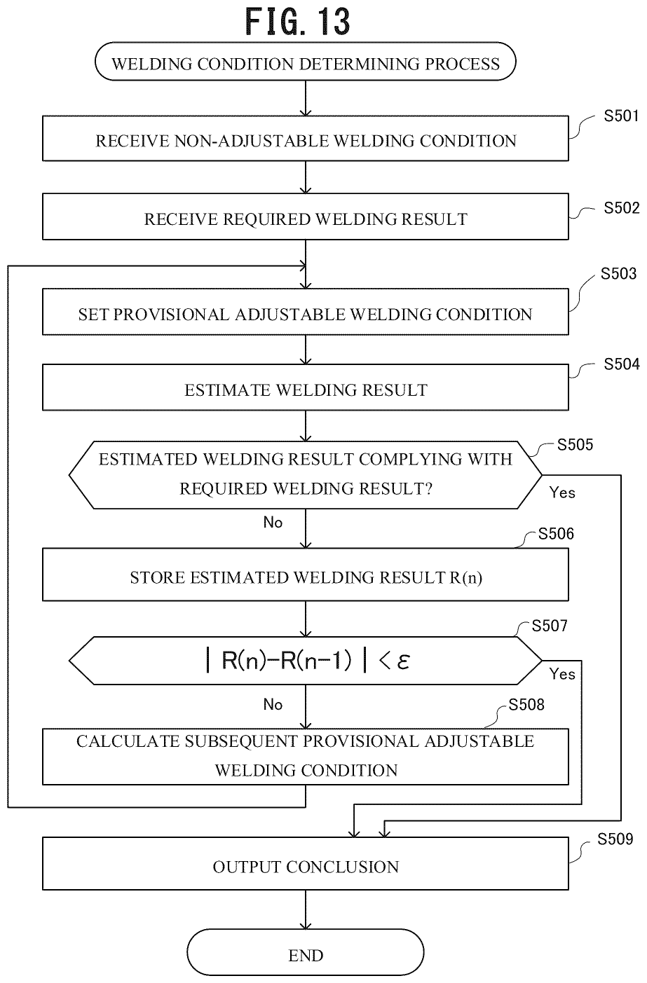

In the above-described embodiment, the number of repetitions or the calculation period is limited in advance. Alternatively, as illustrated in FIG. 13, the welding condition determining process may involve storing an estimated welding result R(n), and determining the termination of the process depending on whether the welding result converges or the absolute difference between R(n) and R(n-1) is smaller than a predetermined threshold ε. Steps S501 to S505 are identical to Steps S101 to S105 of the above-described welding condition determining process. When the estimated welding result is determined to fail to comply with the required welding result (Step S505; No), the estimated welding result R(n) is stored (Step S506). The process then involves determining whether the absolute difference between the estimated welding result R(n) and the previously estimated welding result R(n-1) is smaller than the predetermined threshold ε (Step S507). When the absolute difference between the estimated welding result R(n) and the previously estimated welding result R(n-1) is determined to be equal to or larger than the predetermined threshold ε (Step S507; No), the welding condition setter 111 sets a subsequent provisional adjustable welding condition calculated by a mathematical procedure for optimal exploration, as described above (Step S508). The process then returns to Step S503, and repeats Steps S503 to S508. In contrast, the absolute difference between the estimated welding result R(n) and the previously estimated welding result R(n-1) is determined to be smaller than the predetermined threshold ε (Step S507; Yes), a conclusion of acquisition of no adjustable welding condition that provides the required welding result is output (Step S509), followed by termination of the welding condition determining process. This welding condition determining process is terminated when the absolute difference between the estimated welding result R(n) and the previously estimated welding result R(n-1) is smaller than the predetermined threshold ε, which means convergence of a welding result, and can thus achieve finalization of welding conditions in a short period. The predetermined threshold ε needs to be smaller than the value of the required welding result, and is preferably equal to or smaller than the one tenth of the value of the required welding result.

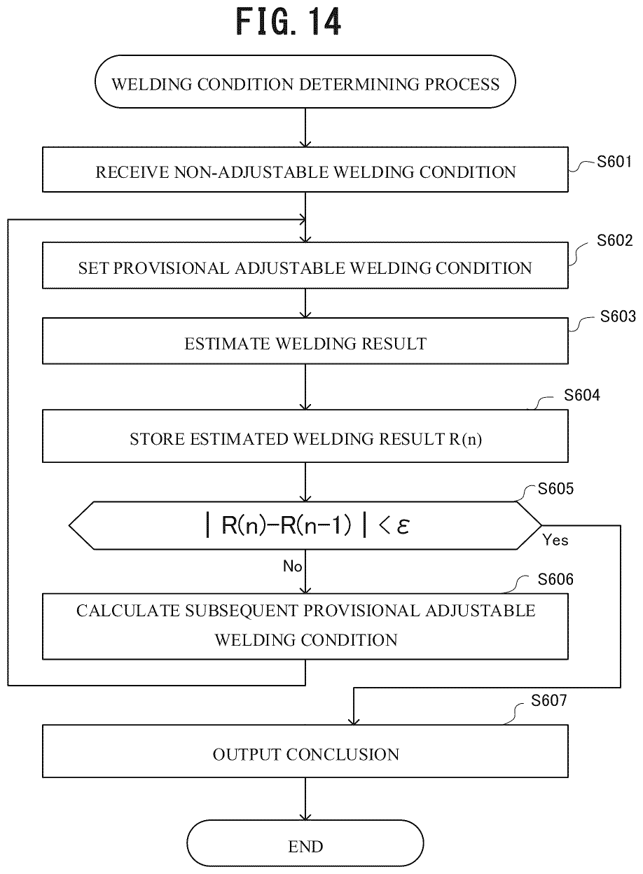

In the above-described embodiment, the welding condition determining system 100 finalizes welding conditions depending on whether the estimated welding result complies with the required welding result. Alternatively, the welding condition determining process may involve calculating a welding condition that provides the most preferable welding result, without determining whether the estimated welding result complies with the required welding result. In this modification, as illustrated in FIG. 14, the welding condition setter 111 first receives data indicating a non-adjustable welding condition (Step S601). The welding condition setter 111 then sets a provisional adjustable welding condition, which is selected from the adjustable welding condition DB 161 (Step S602). The welding result estimator 112 then inputs, into the welding result estimation model 112a, data indicating the non-adjustable welding condition and the provisional adjustable welding condition, and thus estimates a welding result (Step S603). The estimated welding result R(n) is then stored (Step S604). The welding condition determiner 113 then determines whether the absolute difference between the estimated welding result R(n) and the previously estimated welding result R(n-1) is smaller than the predetermined threshold ε (Step S605). When determining that the absolute difference between the estimated welding result R(n) and the previously estimated welding result R(n-1) is equal to or larger than the predetermined threshold ε (Step S605; No), the welding condition setter 111 sets a subsequent provisional adjustable welding condition calculated by a mathematical procedure for optimal exploration, as described above (Step S606). The process then returns to Step S602, and repeats Steps S602 to S606. In contrast, when determining that the absolute difference between the estimated welding result R(n) and the previously estimated welding result R(n-1) is smaller than the predetermined threshold ε (Step S605; Yes), the welding condition determiner 113 outputs a conclusion (Step S607), followed by termination of the welding condition determining process. The welding condition determiner 113 can thus extract an adjustable welding condition that provides a preferable welding result from among the welding results estimated by the welding result estimator 112, and calculate parameters that result in the most preferable estimated welding result.

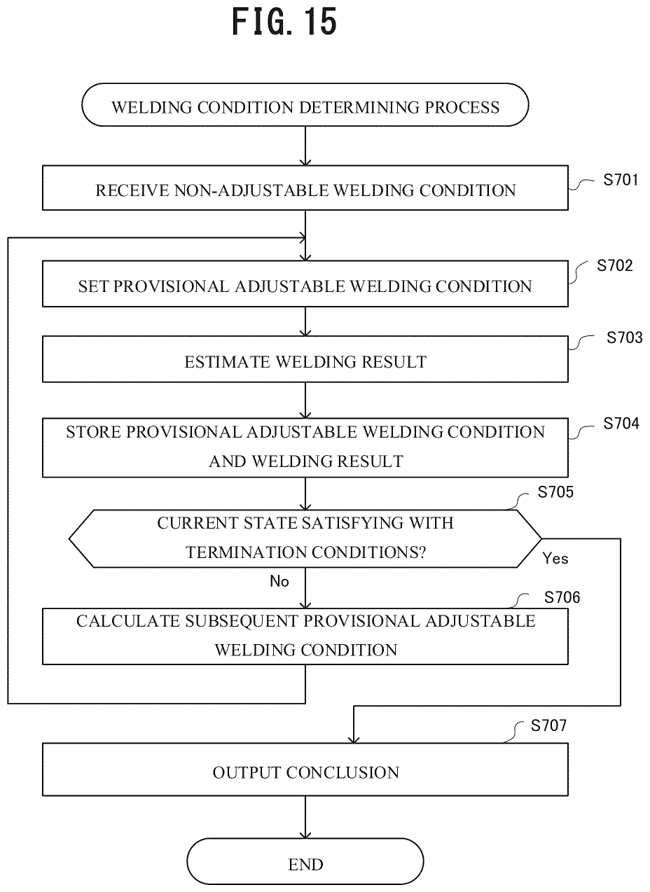

The welding condition determining system 100 may execute the welding condition determining process modified like that illustrated in FIG. 15. In this modification, the welding condition setter 111 receives data indicating a non-adjustable welding condition (Step S701). The welding condition setter 111 then sets a provisional adjustable welding condition, which is selected from the adjustable welding condition DB 161 (Step S702). The welding result estimator 112 then inputs, into the welding result estimation model 112a, the non-adjustable welding condition and the provisional adjustable welding condition, and thus estimates a welding result (Step S703). The welding condition determiner 113 then causes data indicating the provisional adjustable welding condition and the estimated welding result to be stored into the main storage 150 (Step S704). The welding condition determiner 113 then determines whether the current state satisfies termination conditions (Step S705). The determination of whether the current state satisfies the termination conditions depends on how many times Steps S702 to S705 have been repeated, or whether a certain period has elapsed since the time of the initial execution of Step S702. When the current state is determined to fail to satisfy the termination conditions (Step S705; No), the welding condition setter 111 sets a subsequent provisional adjustable welding condition calculated by a mathematical procedure for optimal exploration, as described above (Step S706). The process then returns to Step S702, and repeats Steps S702 to S706. In contrast, when determining that the current state satisfies the termination conditions (Step S705; Yes), the welding condition determiner 113 reads the data indicating the provisional adjustable welding conditions and the data indicating the estimated welding results stored in the main storage 150, and outputs an adjustable welding condition that provides the most preferable welding result, adjustable welding conditions extracted under predetermined conditions, or all the adjustable welding conditions, among the read provisional adjustable welding conditions and estimated welding results (Step S707), followed by termination of the welding condition determining process. This process can readily achieve setting of welding conditions without a required welding result.

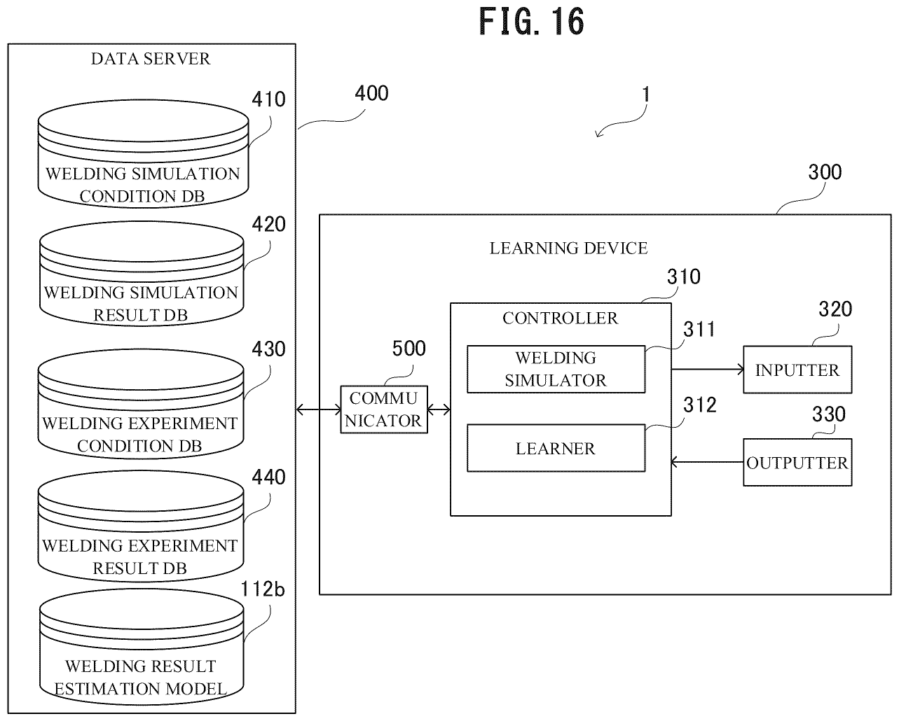

In the above-described embodiment, the welding result estimator 112 estimates a welding result, using the welding result estimation model 112a established based on the welding simulation result DB 420. Alternatively, the welding result estimator 112 may estimate a welding result, using a model established based on both of data on results of simulations and data on results of welding experiments. The following describes a learning system 1 in this modification. As illustrated in FIG. 16, the learning system 1 includes a learning device 300 that executes learning, and a data server 400 that stores data used in the learning. The data server 400 in this modification includes, as well as the welding simulation condition DB 410 and the welding simulation result DB 420 described above, a welding experiment condition DB 430 that stores conditions for welding experiments, and a welding experiment result DB 440 that stores results of welding experiments. The welding experiment condition DB 430 stores welding conditions, like the welding simulation condition DB 410. The welding experiment condition DB 430 preferably stores data on a smaller number of welding experiments or a smaller number of parameters for welding experiments than those in the welding simulation condition DB 410, in view of required tasks for the actual experiments. The welding experiments are executed in accordance with the welding conditions stored in the welding experiment condition DB 430, and results of the welding experiments are input through the inputter 320. The welding experiment result DB 440 thus stores data indicating the results of the welding experiments. The welding experiment result DB 440 stores data indicating the welding conditions stored in the welding experiment condition DB 430, and data indicating results of the welding experiments corresponding to the welding conditions, in association with each other. The learner 312 the learner 312 then executes learning for establishing a welding result estimation model 112b, on the basis of the welding simulation result DB 420 and the welding experiment condition DB 430. The welding result estimation model 112b can be established by the same algorithm as that for establishing the welding result estimation model 112a. The welding result estimation model 112b in any case outputs data indicating a welding result in response to input of data indicating a non-adjustable welding condition and a provisional adjustable welding condition.

After establishment of the welding result estimation model 112b, the welding result estimator 112 of the welding condition determining system 100 inputs, into the welding result estimation model 112b, data indicating a non-adjustable welding condition and a provisional adjustable welding condition, and thus estimates a welding result. Since the welding result estimation model 112b is established based on not only data indicating results of welding simulations but also data containing data indicating results of welding experiments, the welding result estimation model 112b can achieve an output closer to the actual result of a welding experiment regardless of a difference in value between the welding simulation and the welding experiment, and can output welding conditions with higher accuracy, than the welding result estimation model 112a.

Although the controller 110 of the welding condition determining system 100 includes a single processor 140 in the above-described embodiment, the functions may be achieved by cooperation of multiple processors 140. The controller 110 may include multiple main storages 150 and auxiliary storages 160. The above-described hardware configuration including the welding apparatus 200 is a mere example and may be varied or revised into any modification.

The learning system 1, the welding condition determining system 100, and the learning device 300 can be achieved by not only dedicated systems but also ordinary computer systems. For example, a computer program for executing the above-described operations may be stored in non-transitory computer-readable recording mediums, such as flexible disks, compact disc read-only memories (CD-ROMs), and digital versatile disc read-only memories (DVD-ROMs), and distributed. The computer program may then be installed in a computer, so as to configure the learning system 1, the welding condition determining system 100, and the learning device 300 for executing the operations. Alternatively, the computer program may be stored in a storage device included in a server on a communication network, and may be downloaded into an ordinary computer system to configure the learning system 1, the welding condition determining system 100, and the learning device 300.

In the case where the functions of the learning system 1, the welding condition determining system 100, and the learning device 300 are achieved by sharing of an operating system (OS) and an application program or by cooperation of the OS and the application program, only the application program may be stored in a non-transitory recording medium or a storage device.

The computer program may be distributed via a communication network in the form of being superimposed on a carrier wave. For example, the computer program may be posted on a bulletin board system (BBS) on a communication network and may be distributed to computers via the communication network. The computers may activate this computer program and execute the computer program under the control of the OS in the same manner as the other application programs, and thereby execute the above-described operations.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-078041, filed on May 11, 2022, the entire disclosure of which is incorporated by reference herein.

### Appendixes

### (Appendix 1)

A welding condition determining system, including:
a welding condition setter to
   receive data indicating a non-adjustable welding condition and a required welding result, the non-adjustable welding condition being a fixed welding condition for welding of welding targets, and
   set a provisional adjustable welding condition as a flexible welding condition;
a welding result estimator to estimate a welding result, based on the non-adjustable welding condition and the provisional adjustable welding condition, using a welding result estimation model designed to output data indicating an estimated welding result from an output layer in response to input of data indicating the non-adjustable welding condition and the provisional adjustable welding condition into an input layer; and
a welding condition determiner to finalize, based on the welding result estimated by the welding result estimator and the required welding result, a welding condition containing an adjustable welding condition.

### (Appendix 2)

A welding condition determining system, including:
a welding condition setter to
   receive data indicating a non-adjustable welding condition, the non-adjustable welding condition being a fixed welding condition for welding of welding targets, and
   set multiple provisional adjustable welding conditions as flexible welding conditions;
a welding result estimator to estimate, based on the non-adjustable welding condition and the set provisional adjustable welding conditions, welding results for the individual conditions, using a welding result estimation model designed to output data indicating an estimated welding result from an output layer in response to input of data indicating the non-adjustable welding condition and each of the provisional adjustable welding conditions into an input layer; and
a welding condition determiner to extract an adjustable welding condition that provides a preferable welding result among the welding results for the individual conditions estimated by the welding result estimator.

### (Appendix 3)

The welding condition determining system according to Appendix 1 or 2, wherein the welding result estimation model is established based on a welding simulation result database (DB) that stores supervision data, the supervision data containing at least one adjustable welding parameter and at least one or more required welding results or parameters from which required welding results are calculatable.

### (Appendix 4)

The welding condition determining system according to any one of Appendixes 1 to 3, wherein the welding result estimation model includes at least one convolutional layer and at least one pooling layer.

### (Appendix 5)

A learning system, including:
a welding simulation result DB that stores supervision data, the supervision data containing at least one adjustable welding parameter and at least one or more required welding results or parameters from which required welding results are calculatable; and
a learner to execute, based on the supervision data stored in the welding simulation result DB, learning for establishing a welding result estimation model designed to output data indicating a welding result from an output layer in response to input of data indicating an adjustable welding condition into an input layer.

### (Appendix 6)

The learning system according to Appendix 5, wherein the welding result estimation model includes at least one convolutional layer and at least one pooling layer.

### (Appendix 7)

The learning system according to Appendix 5 or 6, further including:
a welding experiment result DB that stores data indicating results of welding experiments, the data containing at least one adjustable welding parameter and at least one or more required welding results or parameters from which required welding results are calculatable, wherein
the learner executes, based on the welding experiment result DB and the welding simulation result DB, learning for establishing the welding result estimation model.

### (Appendix 8)

A welding condition determining method, the method including:
a welding condition setting step of
   receiving data indicating a non-adjustable welding condition and a required welding result, the non-adjustable welding condition being a fixed welding condition for welding of welding targets, and
setting a provisional adjustable welding condition as a flexible welding condition;
a welding result estimating step of estimating a welding result, based on the non-adjustable welding condition and the provisional adjustable welding condition, using a welding result estimation model designed to output data indicating an estimated welding result from an output layer in response to input of data indicating the non-adjustable welding condition and the provisional adjustable welding condition into an input layer; and
a welding condition determining step of finalizing, based on the welding result estimated in the welding result estimating step and the required welding result, a welding condition containing an adjustable welding condition.

### (Appendix 9)

A program configured to cause a computer to function as:
a welding condition setter to
   receive data indicating a non-adjustable welding condition and a required welding result, the non-adjustable welding condition being a fixed welding condition for welding of welding targets, and
   set a provisional adjustable welding condition as a flexible welding condition;
a welding result estimator to estimate a welding result, based on the non-adjustable welding condition and the provisional adjustable welding condition, using a welding result estimation model designed to output data indicating an estimated welding result from an output layer in response to input of data indicating the non-adjustable welding condition and the provisional adjustable welding condition into an input layer; and
a welding condition determiner to finalize, based on the welding result estimated by the welding result estimator and the required welding result, a welding condition containing an adjustable welding condition.

### Reference Signs List

1 Learning system
100 Welding condition determining system
110, 310 Controller
111 Welding condition setter
112 Welding result estimator
112a, 112b Welding result estimation model
113 Welding condition determiner
120, 320 Inputter
130, 330 Outputter
140, 340 Processor
150, 350 Main storage
160, 360 Auxiliary storage
161 Adjustable welding condition DB
162 Welding parameter
163 Adjustable welding parameter
164 Non-adjustable welding parameter
170, 370 Bus
200 Welding apparatus
210 Welding head
220 Welding robot
300 Learning device
311 Welding simulator
312 Learner
400 Data server
410 Welding simulation condition DB
420 Welding simulation result DB
430 Welding experiment condition DB
440 Welding experiment result DB
500 Communicator
R1 First welding target
R2 Second welding target

1. A welding condition determining system, comprising:
welding condition setting circuitry to
receive data indicating a non-adjustable welding condition and a required welding result, the non-adjustable welding condition being a fixed welding condition for welding of welding targets, and
set a provisional adjustable welding condition as a flexible welding condition;
welding result estimating circuitry to estimate a welding result, based on the non-adjustable welding condition and the provisional adjustable welding condition; and
welding condition determining circuitry to finalize, based on the welding result estimated by the welding result estimating circuitry and the required welding result, a welding condition containing an adjustable welding condition.

2. A welding condition determining system, comprising:
welding condition setting circuitry to
receive data indicating a non-adjustable welding condition, the non-adjustable welding condition being a fixed welding condition for welding of welding targets, and
set multiple provisional adjustable welding conditions as flexible welding conditions;
welding result estimating circuitry to estimate, based on the non-adjustable welding condition and the set provisional adjustable welding conditions, welding results for the individual conditions; and
welding condition determining circuitry to extract an adjustable welding condition that provides a preferable welding result from the welding results for the individual conditions estimated by the welding result estimating circuitry.

3. The welding condition determining system according to claim 1, wherein the welding result estimating circuitry estimates the welding results, using a welding result estimation model designed to output data indicating an estimated welding result from an output layer in response to input of data indicating the non-adjustable welding condition and the provisional adjustable welding condition into an input layer

4. The welding condition determining system according to claim 3, wherein the welding result estimation model is obtained based on a welding simulation result database (DB) that stores supervision data, the supervision data containing at least one adjustable welding parameter and at least one or more required welding results or parameters from which required welding results are calculatable.

5. A learning system, comprising:
a welding simulation result DB that stores supervision data, the supervision data containing at least one adjustable welding parameter and at least one or more required welding results or parameters from which required welding results are calculatable; and
learning circuitry to execute, based on the supervision data stored in the welding simulation result DB, learning for establishing a welding result estimation model designed to output data indicating a welding result from an output layer in response to input of data indicating an adjustable welding condition into an input layer.

6. The learning system according to claim 5, wherein the welding result estimation model includes at least one convolutional layer and at least one pooling layer.

7. The learning system according to claim 5, further comprising:
a welding experiment result DB that stores data indicating results of welding experiments, the data containing at least one adjustable welding parameter and at least one or more required welding results or parameters from which required welding results are calculatable, wherein
the learning circuitry executes, based on the welding experiment result DB and the welding simulation result DB, learning for establishing the welding result estimation model.

8. A welding target manufacturing method, the method comprising:
welding the welding target based on a welding condition obtained by the welding condition determining system according to claim 1.

9. (canceled)

10. The welding condition determining system according to claim 3, wherein the welding result estimation model includes at least one convolutional layer and at least one pooling layer.

11. A welding system, comprising:
the welding condition determining system according to claim 1; and
a welding device to weld the welding target based on a welding condition obtained by the welding condition determining system.

12. The welding condition determining system according to claim 2, wherein the welding result estimating circuitry estimates the welding results, using a welding result estimation model designed to output data indicating an estimated welding result from an output layer in response to input of data indicating the non-adjustable welding condition and the provisional adjustable welding condition into an input layer.

13. The welding condition determining system according to claim 12, wherein the welding result estimation model is obtained based on a welding simulation result database (DB) that stores supervision data, the supervision data containing at least one adjustable welding parameter and at least one or more required welding results or parameters from which required welding results are calculatable.

14. The welding condition determining system according to claim 12, wherein the welding result estimation model includes at least one convolutional layer and at least one pooling layer.

15. The learning system according to claim 6, further comprising:
a welding experiment result DB that stores data indicating results of welding experiments, the data containing at least one adjustable welding parameter and at least one or more required welding results or parameters from which required welding results are calculatable, wherein
the learning circuitry executes, based on the welding experiment result DB and the welding simulation result DB, learning for establishing the welding result estimation model.

16. A welding target manufacturing method, the method comprising:
welding the welding target based on a welding condition obtained by the welding condition determining system according to claim 2.
